(19) United States
(12) Patent Application Publication
(10) Pub. No.: US 2019/0003873 A1
(43) Pub. Date: Jan. 3, 2019

(54) Optical System and Method for Measuring Fluid Level

(71) Applicant: Robert Bosch Limitada, Campinas (BR)

(72) Inventors: Marcos Melo ARAUJO, Campinas (BR); Alexandre Denadai RUGERO, Americana (BR); Vaclav NOVAK, Campinas (BR)

(21) Appl. No.: 16/066,731

(22) PCT Filed: Dec. 27, 2016
(86) PCT No.: PCT/BR2016/050351

§ 371 Date: Jun. 28, 2018

(30) Foreign Application Priority Data
Dec. 29, 2015 (BR) BR1020150328591

(51) Int. Cl. G01F 23/292

(52) U.S. Cl. CPC G01F 23/2927; G01F 23/2924

(57) ABSTRACT

The present invention relates to the technological field of meter systems and refers to a device for measuring the level of a fluid, especially, fuel fluids in vehicle tanks. The device in question including an optical guide having interaction surfaces and an light emitter element emitting light beams, an optical system including at least one collimator lens and a light diffuser, and at least one receiving element of the light beams, in which the information captured by the receiving element from the reflection reflected by the inclined interaction surfaces indicates the level of fluid stored in the reservoir. The inclined surfaces can have different angles (a), (β), or an intermediate angle between (a) and (β).

### FIELD OF THE INVENTION

The present invention relates to an optical system and method for measuring the level of at least one type of fluid in a reservoir—more precisely for fuels stored in tanks of motor vehicles—which comprises a series of surfaces which refracts and/or reflects light beams enabling the acquisition of information only, based on optical properties observed in the interaction of light with the fluid and/or with the device. Especially, this invention aims to provide a simple, agile and precise solution for determining the level of fuel fluids arranged in vehicular tanks or similar locations, even in the case of mixtures.

### BACKGROUND OF THE INVENTION

As is well known to those skilled in the art, reservoirs of the most various types are used for storing various fluids, among which we can say tanks of automotive vehicles which are intended for fuel storage. Also, as it is common knowledge to monitor and ensure the proper functioning of vehicles and avoid disorders, it is necessary that users of such vehicles constantly monitor and accurately the amount of fuel remaining in the tank, which is usually done through dials Analog or digital signals located on the vehicle control panel. In this regard, a variety of electronic, mechanical, ultrasonic and optical technologies, for example, can be used for fluid level monitoring and display, which are used in multiple systems, each with its specific peculiarity and applicability.

Essentially, such systems must meet some basic requirements such as space saving, low weight, reliability and durability, and among the most common level meters for vehicle tanks are electronic sensors, flotation systems, magnetic sensors and optical sensors.

One of the systems which uses optical technology and is well known in the art is disclosed in U.S. Pat. No. 6,429,447 which basically comprises a body having an optical guide function, a light beam emitting element and a sensing element. The basic principle of operation of this equipment lies in the refraction and reflection properties of a light beam according to the medium in which it propagates, as well as in the angle of inclination of an interaction surface with light. More precisely, in the system of said document a light beam is reflected by stepped surfaces emanating from the fluid, and refracted by these surfaces when they are immersed in this fluid; so it is possible to measure the level of it. A device of similar characteristics has also been described in U.S. Pat. No. 6,173,609, however both are suitable only for the measurement of predetermined fluids with specific and specific characteristics—that is, they are not effective for the measurement of the level of mixtures.

However, after the advent of flex fuel technology vehicles, which have been designed to operate with various types of fuels used alone or in mixtures—for example: gasoline and alcohol, or gasoline and diesel—in any proportions that can be freely altered by the users at the time of supplying the vehicles, it became necessary that the level measurement systems started operating equally efficiently even in the presence of mixtures in the reservoirs. In this respect, it is noted that the devices in the documents cited above are not suitable for vehicles equipped with “flex” technology.

Based on the foregoing, it is found that the current state of the art lacks practical, effective and reliable solutions in optical device for level measurement and identification of stored fluids, mainly in fuel tanks of automotive vehicles.

### OBJECTIVES OF THE INVENTION

The present invention is basically aimed at solving the technical problem of the difficulties of measuring the level of a fluid in reservoirs of tanks of motor vehicles.

Therefore, it is an object of the present invention to provide an optical system for measuring fluid level in reservoirs intended, more specifically, for use in fuel tanks or the like.

It is also an aim of the present invention to provide a system which operates by analyzing optical properties observed in the interaction between the fluid and/or the light beam device.

Accordingly, it is also an object of the present invention to provide an optical system comprising, basically, a transmitter element, a sensor element, an optical guide, a cooperating collimator or not with at least one diffusing element and a prismatic system.

It is particularly the object of the present invention to provide an optical system comprising two or more surfaces patterns interacting with a light beam.

### SUMMARY OF THE INVENTION

The aforementioned objects are fully achieved by means of an optical system for measuring the level of at least one type of fluid in a reservoir, more specifically for liquid or liquefied fluids, said system comprising at least one optical guide (1) having at least one emitter element (6) of at least one light beam (5), and at least one light beam receiving element (7), said optical guide comprising a housing Provided with interaction surfaces 3 forming at least one optical path 4 for at least one light beam 5 between the emitter element 6 and the receiving element 7.

In a preferred embodiment of the invention, the interaction surfaces 3 are inclined based on at least one of an angle (α), an angle (β), or an intermediate angle between (α) and (β), in which the interaction surfaces (3) are inclined between an angle (α), an angle (β), or an intermediate angle between (α) and (β) reflect at least one light beam (5) starting from the element Emitter (6) for the receiving element (7) in the region of the optical guide (1) that emerges in the fluid of said reservoir; Wherein the information received by the receiving element (7) from the reflection emitted by the interaction surfaces (3) inclined on the basis of at least one of an angle (α), an angle (β), or an angle between (α) and (β) of the region emerging from the optical guide (1) indicates the level of fluid stored in the reservoir.

Also according to a preferred embodiment, the emitter element (6) only emits a light beam, or a plurality of light beams (5) simultaneously, continuously or at predetermined regular intervals, the emitter element (6) comprises an emitter of at least one of the LEDs (light emitting diode), laser and Oled, and may cooperate with a fiber optic system or the like.

The receiving member 7 is also preferably capable of detecting a light beam, or a plurality of light beams 5 simultaneously.

In addition, the receiving element (7) may comprise at least one of an electronic sensor of the type photocell, photodiode, phototransistor, LDR (light dependent resistor), photovoltaic cell, photoconductive, or other like light pickup means.

The invention also relates to a method for measuring fluid level through an optical system comprising the steps of:
emitting at least one light beam (5) through an optical guide (1) causing said light beam (5) to pass through at least one optical system (8);
detecting at least part of the reflected light beam (5) by an interaction surface (3) in an emerging condition (without the presence of fluid); and
identifying the position in which at least part of the light beam (5) has been reflected on at least one interaction surface (3) in emergent condition.

In the method in question, preferably the light beam 5 may be composed of visible light, infrared light or any radiation spectrum.

### BRIEF DESCRIPTION OF DRAWINGS

The present invention will be described in detail on the basis of the following figures, which are of a purely exemplary and non-limiting character, in which:

FIG. 1 schematically shows the optical system for measuring fluid level according to a preferred embodiment of the invention;

FIG. 2 shows a perspective view of a preferred embodiment of an optical guide of said system, which comprises a substantially prismatic body having a plurality of stepped interaction surfaces;

FIG. 3 shows an enlarged detail view of the embodiment shown in FIG. 2;

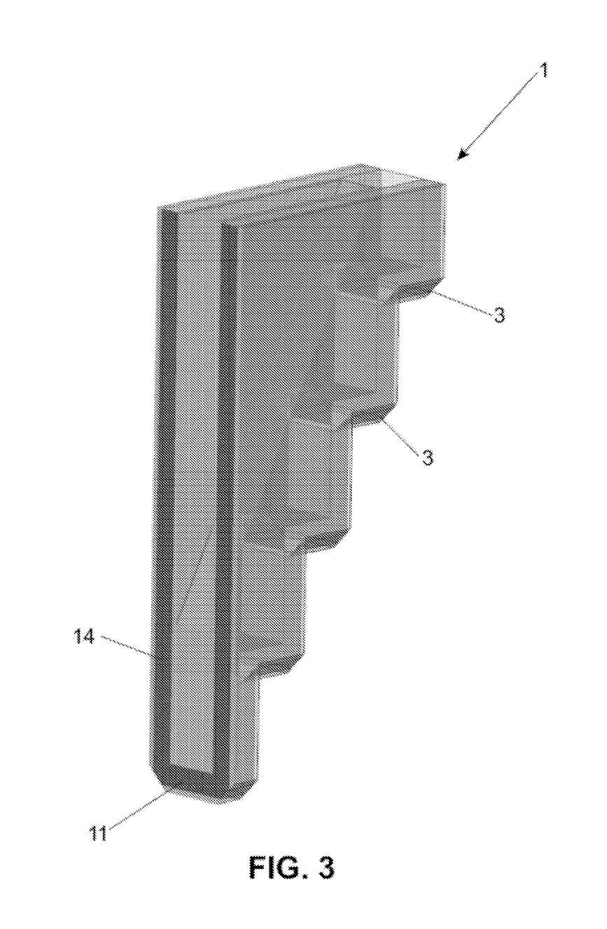

FIG. 4 shows the optical guide shown in FIG. 2, however highlighting beams of light emitted by the emitter element and reflected/refracted on interaction surfaces along said guide;

FIG. 5 shows another enlarged detail of the embodiment shown in FIG. 2, and

FIG. 6 shows a second possible embodiment for the optical system for level measurement and fluid identification of the present invention.

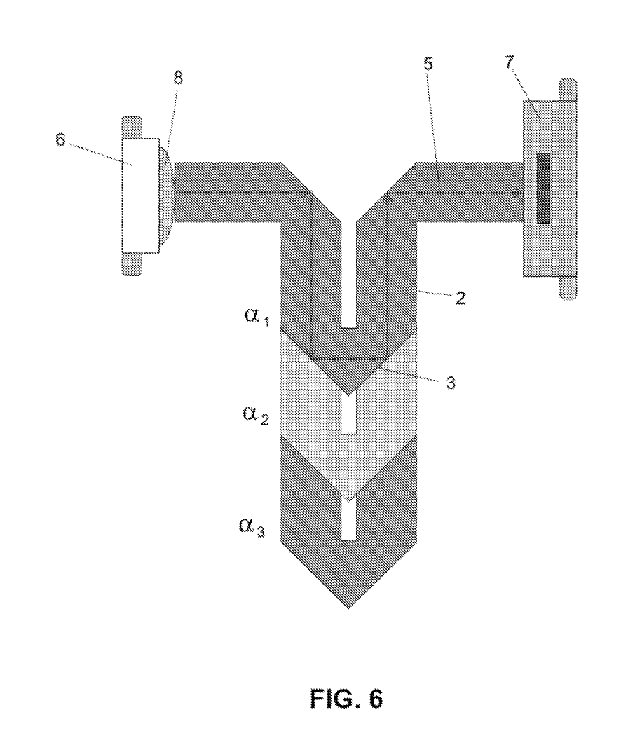

### DETAILED DESCRIPTION OF THE INVENTION

The object of the present invention will be more fully described and explained on the basis of the accompanying drawings, which are of a purely exemplary and non-limiting character, since adaptations and modifications may be made without thereby departing from the scope of the claimed protection.

The present invention relates to an optical system for measuring fluid level in a reservoir specially designed to operate with combustible fluids in tanks of motor vehicles.

Initially, it is important to note that the present invention refers to “fluid” as the physical entity for which it is desired to check the level, whereby volatile elements remaining in the medium are disregarded. In addition, it is valid to note that, for the present invention, an element is only considered “immersed” when immersed in direct contact with a fluid.

More precisely, and as shown in the appended Figures, the system in question basically comprises an emitter element 6 for the emission of light beams 5; At least one light beam receiving element 7; An optical system 8 and at least one optical guide 1 in which the emitter elements 6 and light beam receiver 7 are installed.

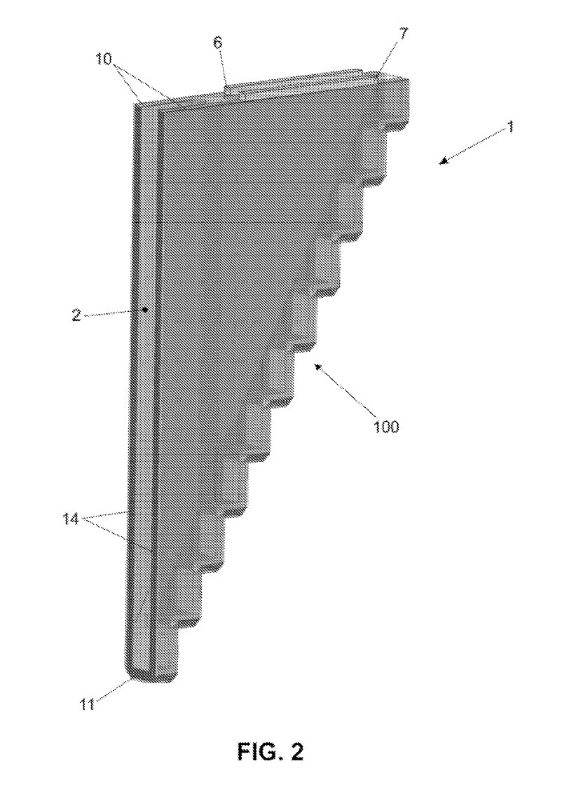

FIG. 2 shows that said optical guide 1 comprises a body which, in the exemplary embodiment of FIG. 2 in question, has a substantially triangular shape, having an upper face 10 and a substantially angled face 100 defined by a plurality of steps , Each provided with cooperating lower surface 11 with vertical walls 14 which eventually form prismatic compartments 2 whose lower vertices have interaction surfaces 3 inclined at an angle α, β or other—that is, it varies according to the types of fluids which Can be employed - said compartments 2 defining at least one optical path 4 for the light beam 5. It should be noted that the surfaces 3 can be inclined at an angle comprising a range of values that can correctly identify the fluid level at the location of Measurement without thereby escaping the scope of protection claimed herein.

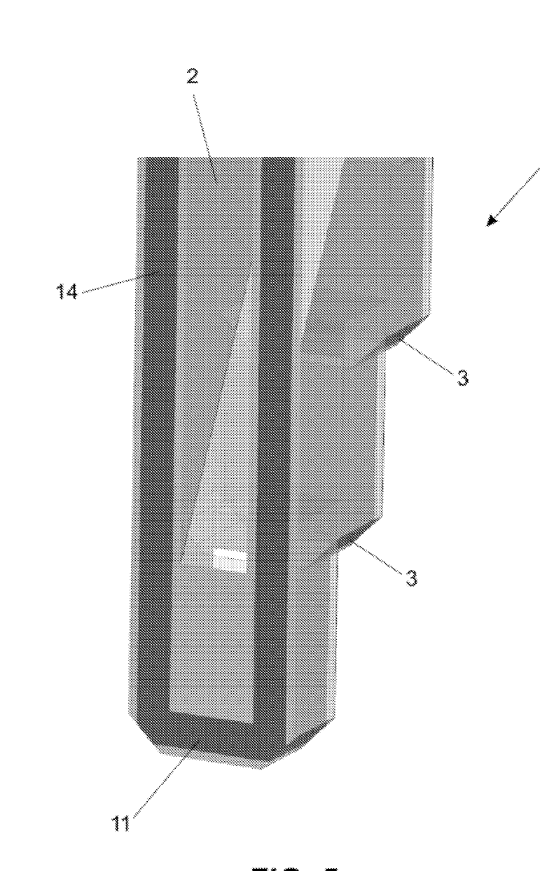

It is important to note that said optical guide 1 may preferably but optionally have an open region which can best be seen through the attached FIG. 5, said open region having as its main purpose reducing the mass of material and ensuring That the optical guide has less loss of light outside the measuring system, thereby ensuring less need for power of the light emitting elements and less sensitivity of the sensing elements.

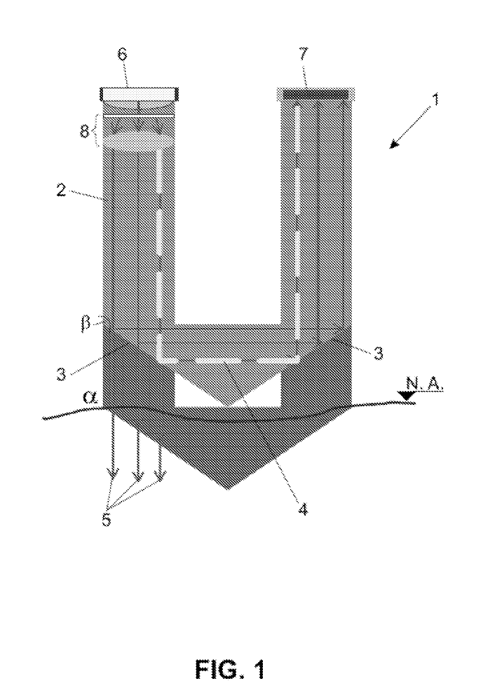

As can be seen in FIG. 1, the optical system of the present invention has the elemental functionality of allowing one or more light beams 5 to travel through the interior thereof so that reflection thereof can be captured and identified by the receiving element 7. Accordingly, said optical guide 1 must be produced in a material that allows the propagation of at least one light beam 5, but preventing or at least reducing any external interferences that may affect the accuracy of the system, the optical guide 1 may have its outer surfaces enveloped or coated by reflective or opaque elements. It should be noted that said material must necessarily withstand direct contact with combustible fluids, and among the materials capable of being used in the manufacture of said optical guide 1 it is possible to mention glass and polymeric materials.

It should be noted that preferably the inclined interaction surfaces 3 of the optical guide—which in the appended figures comprise “steps”—must have a constant inclination with angulation α, β or other, to be used exclusively to identify the presence or not of in order to determine the level of fuel stored inside the reservoir. The amount of interaction surfaces 3 and the inclination thereof may vary according to the need for application without thereby departing from the scope of protection claimed herein. It should be further emphasized that the embodiment shown in FIG. 1 is exemplary only and not limiting, since the position of the system can be rotated at an angle ranging from 0 to 360 degrees without thereby escaping the scope of protection claimed herein.

As already mentioned and can be seen in FIGS. 1, 2 and 4, at one of the upper edges 10 of the optical guide 1 is disposed the emitter element 6 of at least one light beam, preferably in the upper edge 10 Opposite the corresponding receiving element 7 is located, preferably with the optical system 8 consisting of collimating lenses and diffusers, which are arranged in the vicinity of the emitting element 6, which are intended to generate a rectangular light shape to travel the optical path 4 In a preferred embodiment, the emitter element 6 may be defined by a light emitting diode (LED) emitter, laser, Oled and, optionally, be cooperative with a fiber optic system or the like.

Having clarified the constructive peculiarities of the fluid level measurement system, its working principle will be detailed below.

As already mentioned, preferably the system of the present invention will preferably be housed within the fuel tank of a vehicle, cooperating therewith by engagement, interference, or with the aid of any fastening elements, wherein one Once properly installed, the system will operate in direct contact with the fluid being analyzed, for example fuel, logically totally or partially depending on the level of fuel contained in it.

The system operates by the emission of one or more light beams 5 from the emitter element 6, said light beam 5 propagating in a straight line and parallel to the longitudinal axis of the optical guide 1, Precisely along the vertical wall 14 of the prismatic compartment 2, the correct orientation of the light beam 5 being ensured by the action of at least one collimating lens cooperating with or not with at least one diffuser constituent of said optical system 8.

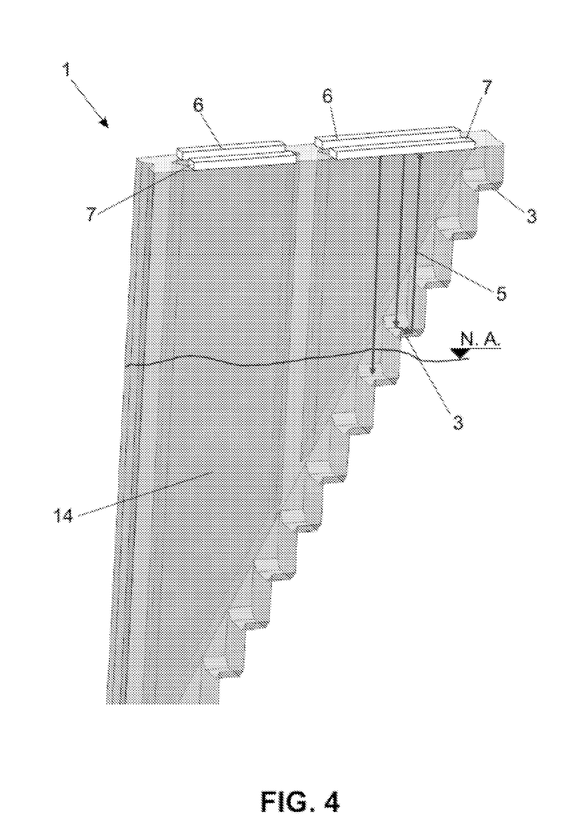

In a preferred embodiment of the present invention and as can be seen in FIG. 4, only one beam or alternatively a plurality of collinear light beams 5 is emitted simultaneously by the emitter element 6, these light beams 5 being Distributed along at least part of one of the upper edges 10 of the prismatic housing 2. It should be noted that the light beams 5 may be emitted either steadily or at regular intervals of time, according to the need for application.

When propagating along the vertical wall 14 of the prismatic housing 2, each light beam 5 impinges on an interaction surface 3 corresponding to the beam emitting position, the result of collision of the light beam 5 with Each interaction surface 3 depends substantially on two factors: the slope of each interaction surface 3 and the location of this surface 3 in relation to the fluid under analysis. At this point it should again be pointed out that the device of the present invention comprises at least one interaction surface pattern 3 inclined at an angle α, β other—i.e. varies according to the quantity and types of fluids that may be employed Vehicle concerned.

For the sake of clarity, again reference is made to FIG. 1 in which it can be seen that multiple light beams 5 are reflected when they collide with the interaction surfaces 3 that are emerged—that is, when the level is below these surfaces. In turn, it is also possible to observe that when there is presence of fluid, the light beams 5 are not reflected by the interaction surfaces 3.

Still looking at FIG. 1, it is seen that the reflected light beams 5 define an optical path 4 (represented by a dashed line), defined by the reflection of said light beams 5 on the two interaction surfaces 3, of So that they return to the upper edge 10 of the optical guide 1, more precisely at the point where the light beam receiving element 7 is arranged.

It is important to note that the light beams 5 are solely reflected by interacting surfaces 3 which are emanated, which have an inclination angle corresponding to the fluids that can be used at the measurement site (i.e., α, β or other point angles or, even, intervals of them—as long as they can identify their presence). This specific slope corresponds to the critical angle of total reflection of the light beam 5 when it is emitted in accordance with the aforementioned conditions and propagates substantially in the air. It is also worth noting that the interaction surfaces 3 of the region emanating from the optical guide 1 will reflect the light beams 5 even though there is presence of volatile elements in the air. Thus, it is clear that the basic principle for level measurement according to the system of the present invention lies in the analysis of the light beams 5 which, once reflected by the interaction surfaces, reach the receiving element 7.

It is furthermore to be understood that the receiving element 7—which may comprise an electronic sensor of the type photocell, photodiode, phototransistor, LDR (light dependent resistor), photovoltaic cell, photoconductive, or other similar light pickup means—is defined by a Capable of receiving light beams 5 and interpreting them. More precisely, the receiving element 7 is able to know from which of the steps—taking into account the exemplary embodiment illustrated in the attached figures—of the inclined surface 100 belong the interaction surfaces 3 in which the light beam 5 has been reflected and, this way, determine the exact position of the fluid level under analysis.

It should be noted that in the air the beams of light are always reflected by the interaction surfaces inclined at an angle or a range of angles corresponding to the air or other gaseous substance that eventually occupies the interior of said reservoir, however when the light beams 5 pass through a liquid medium or any gaseous fuel, the refractive characteristics vary according to the type of fluid, but in a form which is not part of the scope of the present invention.

In this way, the invention allows the measurement of the level of stored fuel, even in mixtures and, therefore, can be employed in tanks of flex type vehicles.

Thus, and briefly, it is noted that the prismatic compartment 2 of the optical guide 1 is developed in order to comprise a plurality of interaction surfaces 3, each of which comprises an inclination α, β, φ or a specific one defined to reflect the light beam 5 in a certain condition which, in this case, is the absence of liquid so that the remaining level of fuel remaining in the reservoir can be identified as accurately as possible.

In addition to the above disclosed device, the present invention also discloses a method for measuring the level of at least one fluid stored in a reservoir—especially, fuel in tanks of automotive vehicles. The method in question comprising the steps of: (i) emitting at least one light beam 5 through an optical guide 1, said beam passing through at least one optical system (8); (ii) detecting at least part of the light beam 5 reflected by an interaction surface 3 in an emerging condition (without the presence of fluid); and (iii) identifying the position at which at least part of the light beam 5 has been reflected on at least one interaction surface 3 in an emerging condition.

In particular, according to a preferred embodiment of the method in question, each interaction surface 3 in an emerging condition is designed to have an inclination angle allowing full reflection of the light beam 5.

It is also worth noting that the light beam 5 may be composed of visible light, infrared light, laser or any type of radiation suitable for the application.

Based on the above description, it is evident that the object of the present invention solves the drawbacks of the present state of the art in an unprecedented, practical and extremely effective manner.

1. Optical system for measuring fluid level in a reservoir, more specifically for liquid or liquefied fluids, in which said system comprises at least one optical guide cooperating with at least one emitter element of at least one light beam, and at least one receiving element of light beams, in which said optical guide comprises a compartment having interaction surfaces that conform at least one optical path for at least one light beam between the emitter element and the receiving element, characterized in that:
interaction surfaces are inclined based on at least one among an angle (α), an angle (β), or an intermediate angle between (α) and (β);
interaction surfaces inclined based on at least one among an angle (α), an angle (β), or an intermediate angle between (α) and (β) reflecting the at least one light beam from the emitter element for the receiving element on the optical guide region emerged on the fluid of said reservoir;
information captured by receiving element coming from reflection emitted by interaction surfaces inclined based on at least one among an angle (α), an angle (β), or an intermediate angle between (α) and (β) of optical guide emerged region indicates the level of fluid stored on the reservoir.

2. System, according to claim 1, characterized in that said emitter element emits a light beam, or a plurality of light beams simultaneously.

3. System, according to claim 1, characterized in that said emitter element emits a light beam, or a plurality of light beams continuously.

4. System, according to claim 1, characterized in that said emitter element emits a light beam, or a plurality of light beams in predetermined regular intervals.

5. System, according to claim 1, characterized in that the receiving element detects the light beam, or a plurality of light beams simultaneously.

6. System, according to claim 1, characterized in that said emitter element comprises an emitter of at least one among LED (light emitting diode), laser and Oled.

7. System, according to claim 1, characterized in that the emitter element cooperates with an optic fiber system or similar.

8. System, according to claim 1, characterized in that the receiving element comprises at least one among a photocell type electronic sensor, photodiode, phototransistor, LDR (light dependent resistor), photovoltaic cell, photoconductive, or other means of light capturing.

9. Method for measuring fluid level, characterized in that said method uses an optical system according to claim 1 and comprises the following steps:
emitting at least one light beam through the optical guide, making said light beam to cross at least one optical system;
detect at least one light beam reflected by an interaction surface in emerged condition (without the presence of fluid);
identifying the position in which at least one part of the light beam was reflected in at least one interaction surface in emerged condition.

10. Method, according to claim 9, characterized in that the light beam is composed of visible light, infrared light or any other radiation spectrum.
